(19) United States
(12) Patent Application Publication
(10) Pub. No.: US 2008/0176169 A1
(43) Pub. Date: Jul. 24, 2008

(54) BINDER COMPOSITION AND PHOTOSENSITIVE COMPOSITION INCLUDING THE SAME

(75) Inventor: Mikyong Yoo, Santa Clara, CA (US)

Correspondence Address: PCE INDUSTRY, INC.;ATT. CHENG-JU CHIANG, 458 E. LAMBERT ROAD, FULLERTON, CA, 92835, US

(73) Assignee: ICF TECHNOLOGY LIMITED., Santa Clara, CA (US)

(21) Appl. No.: 11/625,503

(22) Filed: Jan. 22, 2007

(51) Int. Cl. G03C 1/00

(52) U.S. Cl. 430/286.1; 528/271

(57) ABSTRACT

The present invention relates a binder composition and a photosensitive composition including the binder composition. In one embodiment, a binder composition includes a copolymer of monomer M1, M2, M3 and M4, wherein the monomer M1 can be represented by the following formula:

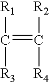

the monomers M2, M3 and M4 can be represented by the following formula, however the monomers M2, M3 and M4 are different from each other,

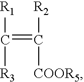

wherein R1, R2, R3 can be selected from the group consisting of hydrogen and alkyl group, R4 is an aromatic group, R5 can be selected from the group consisting of hydrogen, aromatic groups, alkyl groups, substituted alkyl groups and alkyl groups interrupted by an oxygen atom. The copolymer has good developing ability and a black matrices made therefrom has good mechanical properties.

### BACKGROUND

1. Technical Field

The present invention relates to a binder composition for black matrices and a photosensitive composition including the binder composition.

2. Discussion of Related Art

Color filters are widely used in color television sets, liquid crystal display devices, solid image pickup devices, cameras and so forth for separating several types of light having different colors, for example, red, green and blue, from while light. Typically, a color filter includes three or more different hue patterns formed on a transparent substrate and a black matrices. Usually, the hue patterns include red pattern (R), green pattern (G) and blue pattern (B) with a precision of several micrometers (μm). The black matrices are arranged between such hue patterns for separating such hue patterns from each other so as to increase the color contrast of the color filter.

A thin metal film, for example, chromium (Cr), Nickel (Ni), and aluminium (Al) can be used for black matrices. Black matrices made of metal film have excellent light-shielding properties. However, it is too complicated, expensive and hazardous to process this metal.

Therefore, black matrices have been developed using a black pigment and a photosensitive resin, which is cured by ultraviolet radiation and etched using alkaline developing solution. In the development step (i.e., chemical treatment of exposed photo-sensitive sections), the unnecessary pigment and resin components must be dissolved in the alkaline developing solution in a timely manner. However, problems may occur when the unnecessary pigment and resin components still remains after developing or are dissolved too quickly for the developing process to be carried out properly.

Therefore, it is desired to synthesize a binder that can be developed in a desired time of developing process for black matrices and a photosensitive composition for black matrices including the binder.

### SUMMARY OF THE INVENTION

In one preferred embodiment, a binder composition for black matrices includes a copolymer of monomer M1, M2, M3 and M4 wherein a molar percentage of the monomer M1 in the copolymer is in the approximate range from 0% to 80%, a molar percentage of the monomer M2 in the copolymer is in the approximate range from 10% to 90%, a molar percentage of the monomer M3 in the copolymer is in the approximate range from 10% to 90%, and a molar percentage of the monomer M4 in the copolymer is in the approximate range from 0% to 50%,

wherein the monomer M1 is represented by the following formula:

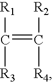

the monomer M2, M3 and M4 are represented by the following formula, however the monomers M2, M3 and M4 are different from each other:

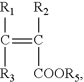

wherein R1, R2, R3 are selected from the group consisting of hydrogen and alkyl group, and R4 is an aromatic group, and
wherein R5 is selected from the group consisting of hydrogen, aromatic group, alkyl group, substituted alkyl group and alkyl group interrupted by an oxygen atom.

In another embodiment, a photosensitive composition for black matrices includes a binder composition, a photopolymerization initiator, a cross-linkable monomer, an organic solvent, and a black pigment, the binder composition includes a copolymer of monomer M1, M2, M3 and M4, wherein a molar percentage of the monomer M1 in the copolymer is in the approximate range from 0% to 80%, a molar percentage of the monomer M2 in the copolymer is in the approximate range from 10% to 90%, a molar percentage of the monomer M3 in the copolymer is in the approximate range from 10% to 90%, and a molar percentage of the monomer M4 in the copolymer is in the approximate range from 0% to 50%,

wherein the monomer M1 is represented by the following formula:

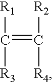

the monomers M2, M3 and M4 are represented by the following formula, however the monomers M2, M3 and M4 are different from each other:

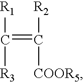

wherein R1, R2, R3 are selected from the group consisting of hydrogen and alkyl group, and R4 is an aromatic group, and
wherein R5 is selected from the group consisting of hydrogen, aromatic group, alkyl group, substituted alkyl group and alkyl group interrupted by an oxygen atom.

### DETAILED DESCRIPTION OF THE INVENTION

A photosensitive composition for color filter black matrices in accordance with a preferred embodiment includes a binder composition, a photopolymerization initiator, a cross-linkable monomer, an organic solvent, and a black pigment.

The binder composition for black matrices includes a copolymer (C) of monomers M1, M2, M3, and M4, wherein the monomer M1 can be represented by the following formula:

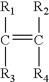

Wherein R1, R2, and R3 can be selected from the group consisting of hydrogen atom and alkyl group having 1 to 4 carbon atoms. R4 can be aromatic group.

Illustrative examples of monomer M1 include aromatic vinyl compounds such as styrene, α-methylstyrene, o-vinyltoluene, m-vinyltoluene, p-vinyltoluene, p-chlorostyrene, o-methoxystyrene, m-methoxystyrene, p-methoxystyrene, o-vinylbenzyl methyl ether, m-vinylbenzyl methyl ether, p-vinylbenzyl methyl ether, o-vinylbenzyl methyl ether, m-vinylbenzyl glycidyl ether, and p-vinylbenzyl glycidyl ether.

The monomers M2, M3 and M4 can be represented by the following formula, however the monomers M2, M3, and M4 are different from each other:

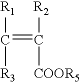

Wherein R1, R2, and R3 can be selected from the group consisting of hydrogen atoms and alkyl groups having 1 to 4 carbon atoms. R5 can be selected from hydrogen atoms, alkyl groups having 1 to 4 carbon atoms, substituted alkyl groups, oxygen interrupted alkyl groups, aromatic groups and alkyl substituted aromatic groups.

Illustrative examples of the monomers M2, M3 and M4 include acrylic acid, methacrylic acid, crotonic acid, α-chloroacrylic acid and cinnamic acid, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, 2-methoxyethyl acrylate, 2-methoxyethyl methacrylate, 2-phenoxyethyl acrylate, 2-phenoxyethyl methacrylate, 2-butoxyethyl acrylate, and 2-butoxyethyl methacrylate.

A molar percentage of monomer M1 in the copolymer is in the approximate range from 0% to 80%. A molar percentage of monomer M2 in the copolymer is in the approximate range from 10% to 90%. A molar percentage of monomer M3 in the copolymer is in the range form 10% to 90%. A molar percentage of monomer M4 in the copolymer is in the range form 0% to 50%. Preferably, the molar percentage of monomer M1 in the copolymer is in the approximate range from 20% to 40%, the molar percentage of monomer M2 in the copolymer is in the approximate range from 30% to 50%, the molar percentage of monomer M3 in the copolymer is in the approximate range from 30% to 50%, and the molar percentage of monomer M4 in the copolymer is in the approximate range from 30% to 50%.

Preferred examples of the copolymer include a copolymer of benzyl methacrylate, methacrylic acid and styrene, copolymer of benzyl methacrylate, methacrylic acid and α-styrene, copolymer of benzyl methacrylate, methacrylic acid and 2-hydroxyethyl methacrylate, and copolymer of benzyl methacrylate, methacrylic acid and 2-butoxyethyl methacrylate.

The weight average molecular weight in terms of polystyrene measured by gel permeation chromatography (GPC; tetrahydrofuran used as an elution solvent) of each copolymer for a black matrices should preferably be between 3,000 and 300,000, and particularly preferably be between 5,000 and 100,000.

Components used for ordinary photopolymerization initiators (for example, radical generators, sensitizers, etc.) may be used in the photopolymerization initiator. Acetophenone compounds can be used as radical generators and benzophenone based compounds can be used as sensitizers. Examples of acetophenone compounds include 2-hydroxy-2-methyl-1-phenylpropan-1-one, 2-2hydroxy-2methyl-1-phenylbutan-1-one, 2-dimethylamino-2-methyl-1-phenylpropan-1-one, 2-diethylamino-2-methyl-1-phenylpropan-1-one. Examples of benzophenone based compounds include benzophenone, 2,4,6-trimethyl-benzophenone, 4-phenylbenzophenone, 4-benzoyl-4′-methylbiphenyl sulfide, 4,4′-bis(dimethylamino)benzophenone, and 4,4′-bis(diethylamino)benzophenone.

Illustrative examples of the cross-linkable monomer include compound having an ethylenically unsaturated group such as: alkyl(meth)acrylates such as methyl(meth)acrylate, ethyl(meth)acrylate, propyl(meth)acrylate, n-butyl(meth)acrylate, isobutyl(meth)acrylate; alicyclic(meth)acrylate such as cyclohexyl(meth)acrylate, bornyl(meth)acrylate, isobornyl(meth)acrylate, dicyclopentenyl(meth)acrylate; aromatic(meth)acrylates such as benzyl(meth)acrylate, nonylphenyl(meth)acrylate, phenyl(meth)acrylate; (meth)acrylates having a hydroxyl group, such as 2-hydroxyethyl(meth)acrylate, hydroxypropyl(meth)acrylate; di(meth)acrylates such as ethylene glycol di(meth)acrylate, diethylene glycol di(meth)acrylate, triethylene glycol di(meth)acrylate.

The organic solvent is not particularly limited, so long as it dissolves or disperses the above-mentioned respective components that constitute the photosensitive composition for color filter black matrices. Specific examples thereof include methanol, ethanol, isopropanol, toluene, xylene, ethylbenzene, cyclohexane, isophorone, cellosolve acetate, diethylene glycol dimethyl ether, ethylene glycol diethyl ether, methyl cellosolve, ethyl cellosolve, butyl cellosolve, propylene glycol monomethyl ether, propylene glycol monomethyl ether acetate, propylene glycol monomethyl ether acetate, diethylene glycol ethyl ether acetate, methyl methoxypropionate, ethyl methoxypropionate, methyl ethoxypropionate, ethyl ethoxypropionate, ethyl acetate, isoamyl acetate, ethyl lactate, acetone, methyl ketone, cyclohexanone, N,N-dimethylformamide, and N-methylpyrrolidone. They may be used singly or two or combination of them.

The black pigment can be selected from the group consisting of carbon black, acetylene black, lamp black, graphite, iron black, aniline black, cyanine black, titanium black or mixture of red, green and blue pigments. Particularly preferred is the black pigment carbon black in the view of its light shielding ratio and image characteristics.

The present polymer binder in accordance with the preferred embodiment can be etched in a desired time in the development process for making the black matrices, and thus can increase the accepting rate (i.e. the number of products accepted during quality control) of the color filters. Additionally, the polymer binder has good binding property for carbon black and great adhesion strength to the substrate that it is disposed on.

A method for synthesizing the binder composition will become apparent from the following detailed examples:

### SYNTHESIS EXAMPLE 1

In a four-neck reaction flask equipped with a dropping funnel, a thermometer, a reflux condenser with nitrogen flow, and a stirrer, 43 parts by mass of benzyl methacrylate, 7 parts by mass of methacrylic acid, 0.5 parts by mass of 2,2′-Azobisisobutyronitrile, 0.4 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes. The obtained copolymer had an acid value of 83 mgKOH/g.

### SYNTHESIS EXAMPLE 2

In a four-neck reaction flask equipped with a dropping funnel, a thermometer, a reflux condenser with nitrogen flow, and a stirrer, 41 parts by mass of benzyl methacrylate, 8 parts by mass of methacrylic acid, 4 parts by mass of α-methyl styrene, 0.5 parts by mass of 2,2′-Azobisisobutyronitrile, 0.4 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes. The obtained copolymer had an acid value of 80 mgKOH/g.

### SYNTHESIS EXAMPLE 3

In a four-neck reaction flask equipped with a dropping funnel, a thermometer, a reflux condenser with nitrogen flow, and a stirrer, 40 parts by mass of benzyl methacrylate, 7 parts by mass of methacrylic acid, 5 parts by mass of 2-hydroxyethyl methacrylate, 0.5 parts by mass of 2,2′-Azobisisobutyronitrile, 0.4 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes. The obtained copolymer had an acid value of 86 mgKOH/g.

### SYNTHESIS EXAMPLE 4

In a four-neck reaction flask equipped with a dropping funnel, a thermometer, a reflux condenser with nitrogen flow, and a stirrer, 41 parts by mass of benzyl methacrylate, 8 parts by mass of methacrylic acid, 4 parts by mass of styrene, 0.5 parts by mass of 2,2′-Azobisisobutyronitrile, 0.4 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes. The obtained copolymer had an acid value of 86 mgKOH/g.

### SYNTHESIS EXAMPLE 5

In a four-neck reaction flask equipped with a dropping funnel, a thermometer, a reflux condenser with nitrogen flow, and a stirrer, 35 parts by mass of benzyl methacrylate, 8 parts by mass of methacrylic acid, 9 parts by mass of 2-hydroxyethyl methacrylate, 0.5 parts by mass of 2,2′-Azobisisobutyronitrile, 0.4 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes. The obtained copolymer had a molecular weight of 40,000 in terms of polystyrene as measured by GPC.

### SYNTHESIS EXAMPLE 6

In a four-neck reaction flask equipped with a dropping funnel, a thermometer, a reflux condenser with nitrogen flow, and a stirrer, 40 parts by mass of benzyl methacrylate, 7 parts by mass of methacrylic acid, 5 parts by mass of 2-hydroxyethyl methacrylate, 0.5 parts by mass of 2,2′-Azobisisobutyronitrile, 1 mass part of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes. The obtained copolymer had an weight molecular weight of 22,000 in terms of polystyrene as measured by GPC.

### SYNTHESIS EXAMPLE 7

In a four-neck reaction flask equipped with a dropping funnel, a thermometer, a reflux condenser with nitrogen flow, and a stirrer, 40 parts by mass of benzyl methacrylate, 7 parts by mass of methacrylic acid, 5 parts by mass of 2-hydroxyethyl methacrylate, 0.5 parts by mass of 2,2′-Azobisisobutyronitrile, 1.5 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes. The obtained copolymer had a molecular weight of 14,000 in terms of polystyrene as measured by GPC.

### SYNTHESIS EXAMPLE 8

In a four-neck reaction flask equipped with a dropping funnel, a thermometer, a reflux condenser with nitrogen flow, and a stirrer, 30 parts by mass of benzyl methacrylate, 8 parts by mass of methacrylic acid, 15 parts by mass of 2-hydroxyethyl methacrylate, 0.5 parts by mass of 2,2′-Azobisisobutyronitrile, 0.4 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes.

### SYNTHESIS EXAMPLE 9

In a four-neck reaction flask equipped with a dropping funnel, a thermometer, a reflux condenser with nitrogen flow, and a stirrer, 40 parts by mass of benzyl methacrylate, 7 parts by mass of methacrylic acid, 5 parts by mass of 2-butoxyethyl methacrylate, 0.5 parts by mass of 2,2′-Azobisisobutyronitrile, 0.4 parts by mass of iso octyl 3-mercaptopropionate were dissolved in 50 parts by mass of cyclohexanone, and the inside of the four-necked flask was purged with nitrogen for about one hour. Furthermore, the temperature was elevated to 75° C. in an oil bath. After polymerization was performed for 1 hour, 40 parts by mass of tetrahydrofuran was added into the four-neck reaction flask, and then the mixture was purified in 600 parts by mass of hexanes.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A binder composition for black matrices comprising:
a copolymer of monomer M1, M2, M3 and M4, wherein a molar percentage of the monomer M1 in the copolymer is in the approximate range from 0% to 80%, a molar percentage of the monomer M2 in the copolymer is in the approximate range from 10% to 90%, a molar percentage of the monomer M3 in the copolymer is in the approximate range from 10% to 90%, and a molar percentage of the monomer M4 in the copolymer is in the approximate range from 0% to 50%, wherein the monomer M1 is represented by the following formula: 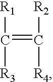
the monomers M2, M3 and M4 are represented by the following formula, however the monomers M2, M3 and M4 are different from each other: 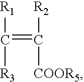
wherein R1, R2, R3 are selected from the group consisting of hydrogen and alkyl group, and R4 is an aromatic group,
wherein R5 is selected from the group consisting of hydrogen, aromatic group, alkyl group, substituted alkyl group and alkyl group interrupted by oxygen atom.

2. The binder composition for black matrices as claimed in claim 1, wherein the monomer M1 is selected from the group consisting of styrene, α-methylstyrene, o-vinyltoluene, m-vinyltoluene, p-vinyltoluene, p-chlorostyrene, o-methoxystyrene, m-methoxystyrene, p-methoxystyrene, o-vinylbenzyl methyl ether, m-vinylbenzyl methyl ether, p-vinylbenzyl methyl ether, o-vinylbenzyl methyl ether, m-vinylbenzyl glycidyl ether, and p-vinylbenzyl glycidyl.

3. The binder composition for black matrices as claimed in claim 1, wherein the monomer M2, M3, and M4 are selected from the group consisting of acrylic acid, methacrylic acid, crotonic acid, α-chloroacrylic acid and cinnamic acid, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, 2-methoxyethyl acrylate, 2-methoxyethyl methacrylate, 2-phenoxyethyl acrylate, 2-phenoxyethyl methacrylate, 2-butoxyethyl acrylate, and 2-butoxyethyl methacrylate.

4. The binder composition for black matrices as claimed in claim 1, wherein the copolymer is selected from the group consisting of copolymer of benzyl methacrylate, methacrylic acid and styrene, copolymer of benzyl methacrylate, methacrylic acid and α-styrene, copolymer of benzyl methacrylate, methacrylic acid and 2-hydroxyethyl methacrylate, and copolymer of benzyl methacrylate, methacrylic acid and 2-butoxyethyl methacrylate.

5. The binder composition for black matrices as claimed in claim 1, wherein a molar percentage of the monomer M1 in the copolymer is in the approximate range from 20% to 40%, a molar percentage of the monomer M2 in the copolymer is in the approximate range from 30% to 50%, a molar percentage of the monomer M3 in the copolymer is in the approximate range from 30% to 50%, and the molar percentage of monomer M4 in the copolymer is in the approximate range from 30% to 50%.

6. The binder composition for black matrices as claimed in claim 1, wherein an average molecular weight of the copolymer is in the approximate range from 3,000 to 300,000.

7. The binder composition for black matrices as claimed in claim 6, wherein the weight average molecular weight of the copolymer is in the approximate range from 5,000 to 100,000.

8. A photosensitive composition for black matrices, comprising:
a binder composition,
a photopolymerization initiator,
a cross-linkable monomer,
an organic solvent, and
a black pigment,
wherein the binder composition comprises a copolymer of monomer M1, M2, M3 and M4, wherein a molar percentage of the monomer M1 in the copolymer is in the approximate range from 0% to 80%, a molar percentage of the monomer M2 in the copolymer is in the approximate range from 10% to 90%, a molar percentage of the monomer M3 in the copolymer is in the approximate range from 10% to 90%, and a molar percentage of the monomer M4 in the copolymer is in the approximate range from 0% to 50%, wherein the monomer M1 is represented by the following formula: 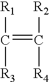
the monomers M2, M3 and M4 are represented by the following formula, however the monomers M2, M3 and M4 are different from each other: 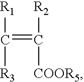
wherein R1, R2, R3 are selected from the group consisting of hydrogen and alkyl group, and R4 is an aromatic group, and
wherein R5 is selected from the group consisting of hydrogen, aromatic group, alkyl group, substituted alkyl group and alkyl group interrupted by oxygen atom.

9. The photosensitive composition for black matrices as claimed in claim 8, wherein monomer M1 can be selected from the group consisting of styrene, α-methylstyrene, o-vinyltoluene, m-vinyltoluene, p-vinyltoluene, p-chlorostyrene, o-methoxystyrene, m-methoxystyrene, p-methoxystyrene, o-vinylbenzyl methyl ether, m-vinylbenzyl methyl ether, p-vinylbenzyl methyl ether, o-vinylbenzyl methyl ether, m-vinylbenzyl glycidyl ether, and p-vinylbenzyl glycidyl.

10. The photosensitive composition for black matrices as claimed in claim 8, wherein the monomer M2, M3 and M4 are selected from the group consisting of acrylic acid, methacrylic acid, crotonic acid, α-chloroacrylic acid and cinnamic acid, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, 2-methoxyethyl acrylate, 2-methoxyethyl methacrylate, 2-phenoxyethyl acrylate, 2-phenoxyethyl methacrylate, 2-butoxyethyl acrylate, and 2-butoxyethyl methacrylate.

11. The photosensitive composition for black matrices as claimed in claim 8, wherein the copolymer is selected from the group consisting of copolymer of benzyl methacrylate, methacrylic acid and styrene, copolymer of benzyl methacrylate, methacrylic acid and α-styrene, copolymer of benzyl methacrylate, methacrylic acid and 2-hydroxyethyl methacrylate, and copolymer of benzyl methacrylate, methacrylic acid and 2-butoxyethyl methacrylate.

12. The photosensitive composition for black matrices as claimed in claim 8, wherein a molar percentage of the monomer M1 in the copolymer is in the approximate range from 20% to 40%, a molar percentage of monomer M2 in the copolymer is in the approximate range from 30% to 50%, a molar percentage of monomer M3 in the copolymer is in the approximate range from 30% to 50%, and the molar percentage of monomer M4 in the copolymer is in the approximate range from 30% to 50%.

13. The photosensitive composition for black matrices as claimed in claim 8, wherein a weight average molecular weight of the copolymer is in the approximate range from 3,000 to 300,000.

14. The photosensitive composition for black matrices as claimed in claim 13, wherein a weight average molecular weight of the copolymer is in the approximate range from 5,000 to 100,000.

15. The photosensitive composition for black matrices as claimed in claim 8, wherein the black pigment is selected from the group consisting of carbon black, acetylene black, lamp black, graphite, iron black, aniline black, cyanine black, titanium black or mixture of red, green and blue pigments.

16. The photosensitive composition for black matrices as claimed in claim 8, wherein the photopolymerization initiator is selected from the group consisting of 2-hydroxy-2-methyl-1-phenylpropan-1-one, 2-2hydroxy-2methyl-1-phenylbutan-1-one, 2-dimethylamino-2-methyl-1-phenylpropan-1-one, 2-diethylamino-2-methyl-1-phenylpropan-1-one, benzophenone, 2,4,6-trimethyl-benzophenone, 4-phenylbenzophenone, 4-benzoyl-4′-methylbiphenyl sulfide, 4,4′-bis(dimethylamino)benzophenone, and 4,4′-bis(diethylamino)benzophenone.

17. The photosensitive composition for black matrices as claimed in claim 8, wherein the cross-linkable monomer is selected from the group consisting of alkyl(meth)acrylates such as methyl(meth)acrylate, ethyl(meth)acrylate, propyl(meth)acrylate, n-butyl(meth)acrylate, isobutyl(meth)acrylate; alicyclic(meth)acrylate such as cyclohexyl(meth)acrylate, bornyl(meth)acrylate, isobornyl(meth)acrylate, dicyclopentenyl(meth)acrylate; aromatic(meth)acrylates such as benzyl(meth)acrylate, nonylphenyl(meth)acrylate, phenyl(meth)acrylate; (meth)acrylates having a hydroxyl group, such as 2-hydroxyethyl(meth)acrylate, hydroxypropyl(meth)acrylate; di(meth)acrylates such as ethylene glycol di(meth)acrylate, diethylene glycol di(meth)acrylate, triethylene glycol di(meth)acrylate.
